(19) United States
(12) Patent Application Publication
(10) Pub. No.: US 2020/0082176 A1
(43) Pub. Date: Mar. 12, 2020

(54) SYSTEMS AND METHODS FOR EXTENDING DETACHABLE AUTOMOBILE SENSOR CAPABILITIES FOR IDENTIFICATION OF SELECTED OBJECT TYPES

(71) Applicant: Toyota Motor Engineering & Manufacturing North America, Inc., Plano, TX (US)

(72) Inventors: Scott L. Frederick, Brighton, MI (US); Scott P. Robison, Dexter, MI (US)

(21) Appl. No.: 16/128,796

(22) Filed: Sep. 12, 2018

(51) Int. Cl. G06K 9/00; B60R 11/04

(52) U.S. Cl. CPC G06K 9/00791; B60R 2011/0049; B60R 11/04

(57) ABSTRACT

Systems, methods, and other embodiments described herein relate to a manner of extending the use of originally-equipped automotive vehicle sensors to identify selected object types. In one embodiment, a method includes acquiring data from a vehicle-equipped detachable sensor of an environment around a non-automotive entity when the vehicle-equipped detachable sensor is mounted to the non-automotive entity. The vehicle-equipped detachable sensor is capable of sensing a portion of an environment around an automotive vehicle and configured to communicate with a mobile device. The vehicle-equipped detachable sensor is also structured to be detached from the automotive vehicle and mounted to the non-automotive entity. The method includes identifying, from the acquired data, an object based on a selected object type received from the mobile device. The method also includes, in response to identifying the object from the acquired data, outputting at least one notification signal to the mobile device.

### TECHNICAL FIELD

The subject matter described herein relates generally to sensors used in vehicle operation and, more particularly, to detaching the sensors from the automobile and utilizing these sensors to detect specific types of objects.

### BACKGROUND

Automobiles are increasingly equipped with sensors that are configured to detect information about the surrounding environment, e.g., obstacles, roadways, etc. The information may be used by automobile systems to assist a driver in identifying and avoiding collisions with detected objects in the surrounding environment. Automobiles are parked and are sometimes underutilized for a portion of their lifespan. Current systems do not yet take advantage of otherwise idle, underutilized and in some instances, expensive sensor technology.

### SUMMARY

Example systems and methods are disclosed herein that relate to a manner of extending the use of originally-equipped automotive vehicle sensors to identify selected object types. In one embodiment, an object identification system is disclosed. The object identification system includes a vehicle-equipped detachable sensor capable of sensing a portion of an environment around an automotive vehicle. The vehicle-equipped detachable sensor is configured to communicate with a mobile device and is structured to be detached from the automotive vehicle and mounted to a non-automotive entity. The object identification system also includes one or more processors and a memory that is communicably coupled to the one or more processors. The memory stores a monitoring module including instructions that when executed by the one or more processors cause the one or more processors to acquire data from the vehicle-equipped detachable sensor of an environment around the non-automotive entity when the vehicle-equipped detachable sensor is mounted to the non-automotive entity. The memory also stores an identification module including instructions that when executed by the one or more processors cause the one or more processors to identify, from the acquired data, an object based on a selected object type received from the mobile device. Further, the memory stores a notification module including instructions that when executed by the one or more processors cause the one or more processors to, in response to identifying the object from the acquired data, output at least one notification signal to the mobile device.

In another embodiment, a method is disclosed. The method includes acquiring data from a vehicle-equipped detachable sensor of an environment around a non-automotive entity when the vehicle-equipped detachable sensor is mounted to the non-automotive entity. The vehicle-equipped detachable sensor is capable of sensing a portion of an environment around an automotive vehicle and configured to communicate with a mobile device. The vehicle-equipped detachable sensor is also structured to be detached from the automotive vehicle and mounted to the non-automotive entity. The method includes identifying, from the acquired data, an object based on a selected object type received from the mobile device. The method also includes, in response to identifying the object from the acquired data, outputting at least one notification signal to the mobile device.

In another embodiment, a non-transitory computer-readable medium is disclosed. The non-transitory computer-readable medium stores instructions that when executed by one or more processors cause the one or more processor to perform the disclosed functions. The instructions include instructions to acquire data from a vehicle-equipped detachable sensor of an environment around a non-automotive entity when the vehicle-equipped detachable sensor is mounted to the non-automotive entity. The vehicle-equipped detachable sensor is capable of sensing a portion of an environment around an automotive vehicle and configured to communicate with a mobile device. The vehicle-equipped detachable sensor is also structured to be detached from the automotive vehicle and mounted to the non-automotive entity. The instructions include instructions to identify, from the acquired data, an object based on a selected object type received from the mobile device. Further, the instructions include instructions to, in response to identifying the object from the acquired data, output at least one notification signal to the mobile device.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates perspective views of an embodiment of an object identification system where a non-automotive entity receives a vehicle-equipped detachable sensor from an automotive vehicle.

FIG. 2 is a block diagram of FIG. 1 illustrating the object identification system receiving the vehicle-equipped detachable sensor from the automotive vehicle.

FIG. 3 illustrates one embodiment of an object identification system that is associated with extending the use of the vehicle-equipped detachable sensors to identify selected object types.

FIG. 4 is a perspective view of an example object identification system that identifies and tracks a selected object type.

FIG. 5 is a flowchart illustrating one example of a method that is associated with extending the usage of the vehicle-equipped detachable sensor from an automotive vehicle to a non-automotive entity.

FIG. 6 is a block diagram illustrating examples of how the object identification system extends the usage of the vehicle-equipped detachable sensors for remote operations.

### DETAILED DESCRIPTION

Systems, methods and other embodiments associated with extending the usage of originally-equipped automotive vehicle sensors to take advantage of their rich environmental sensing capabilities are disclosed herein. Leveraging the sensor technology for use with other modes of transportation (herein referred to as “non-automotive entities”) while an automotive vehicle is sitting unused and/or the sensor is not being utilizing can provide operators of the non-automotive entities with an increased perception of their surroundings leading to identifying specific objects in the environment around the operator. Furthermore, the non-automotive entity may be a user who adapts the sensor technology as a wearable device. In this case, the non-automotive entity, i.e., the wearable device user, may also benefit from the increased perception offered by the temporarily unused originally-equipped automotive vehicle sensors.

Accordingly, in one or more embodiments, an object identification system includes an original vehicle-equipped automotive sensor that is structured to be detached from the automotive vehicle and mounted to the non-automotive entity, e.g., a bicycle, a motorcycle, an all-terrain vehicle (ATV), etc., so that the operator of the non-automotive entity may benefit from object identification while engaging with the other modes of transportation. When the non-automotive entity is the wearable device user, the vehicle-equipped automotive sensor is structured to be detached from the automotive vehicle and mounted to the wearable device user. In this case, the wearable device user may benefit from object identification while engaging in sporting activities (e.g., hunting, fishing, bird watching, skiing, jogging, etc.), personal activities (e.g., locating lost items, locating lost persons in a crowd, etc.), police matters (e.g., identification of objects at night, identification of a specific person in a crowd, etc.

Additionally, or alternatively, the object identification system, in one embodiment, can track the identified object and provide notification via a mobile device that the identified object matching a selected object type is, for example, moving toward the non-automotive entity. The object identification system, in another arrangement, can predict a trajectory that the identified object is heading.

In either case, the object identification system takes advantage of temporarily unused vehicle-equipped detachable sensors and repurposes them to enhance the ability of the operator or wearable device user to identify objects in an environment around the non-automotive entity. In this way, the object identification system improves environmental perception by providing notification when the specific objects are present in the surrounding area. In some situations, the object identification system may track the specified object and notify the operator or wearable device user via the mobile device of the movement of these objects.

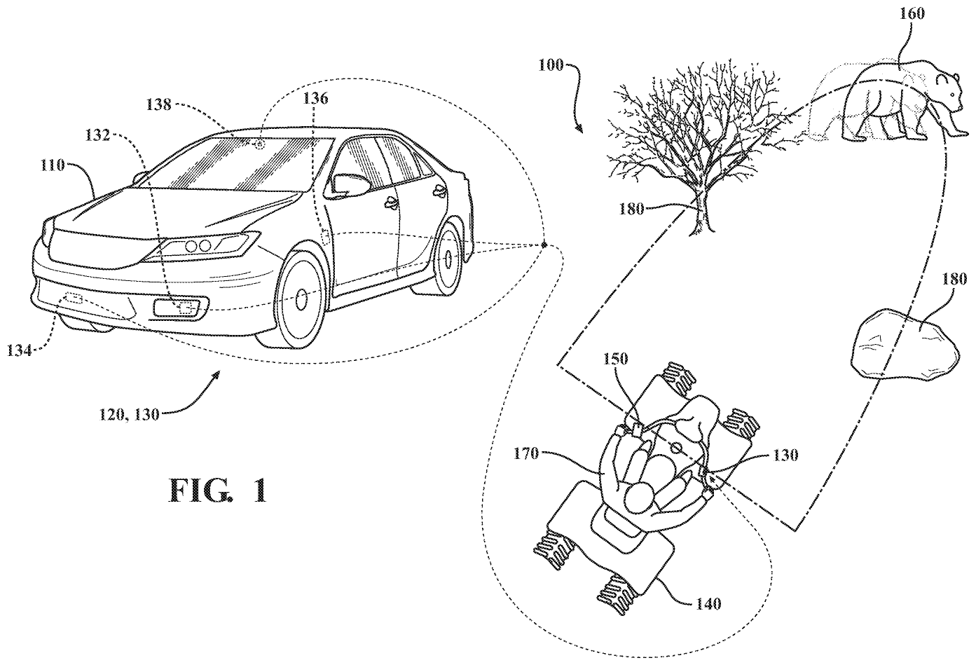

FIG. 1 is an illustration of an object identification system 100 configured to incorporate one or more vehicle-equipped detachable sensors 130 from an automotive vehicle 110, in accordance with embodiments described herein. The object identification system 100 includes at one or more of the vehicle-equipped detachable sensors 130, a non-automotive entity 140 and a mobile device 150. For example, FIG. 1 shows the automotive vehicle 110 having a plurality of vehicle-equipped environmental sensors 120 configured as vehicle-equipped detachable sensors 130, e.g., a radar sensor 132, a LIDAR sensor 134, a sonar sensor 136 and a camera 138. The vehicle-equipped detachable sensors 130 are the vehicle-equipped environmental sensors 120 that are: structured to be detached from the automotive vehicle 110 and mounted to the non-automotive entity 140 when the automotive vehicle 110 is not in use or not taking advantage of the vehicle-equipped detachable sensor 130, capable of sensing a portion of an environment around the automotive vehicle 110 and configured to communicate with the mobile device 150.

As may be appreciated, in the context of vehicle manufacture, vehicle-equipped sensing devices may refer to those sensors assembled and installed during new automotive vehicle construction. Various vehicle-equipped sensor manufacturers may provide these devices to the specifications and requirements of the final automotive vehicle assembly and may have a relationship with the original automotive vehicle manufacturer, and accordingly, have access to operational and/or functional specifications for device integration with the automotive vehicle 110. The vehicle-equipped sensing devices, for example, the vehicle-equipped environmental sensors 120 and the vehicle-equipped detachable sensors 130, as shown in FIG. 1, may be part of an overall sensor system (not shown) defined for the automotive vehicle 110.

In contrast, aftermarket, third-party or non-vehicle-equipped sensing devices, are those sensing devices that may be installed as replacements for after-factory assembly. Non-vehicle-equipped manufacturers may not have access to the specifications and requirements of the original automotive vehicle manufacturer, and accordingly, non-vehicle-equipped sensing devices may not have the capacity to integrate with the sensor system of the automotive vehicle 110.

Additionally, some of the possible elements of the object identification system 100 are shown in FIG. 1 and will be described along with subsequent figures. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

The object identification system 100 may acquire data from the vehicle-equipped detachable sensors 130 of an environment around the non-automotive entity 140 when the vehicle-equipped detachable sensors 130 are mounted to the non-automotive entity 140. Further, based on a selected object type received from the mobile device 150, the object identification system 100 identifies, from the acquired data, an object 160 matching the selected object type. Furthermore, in response to identifying the object 160 from the acquired data, the object identification system 100 notifies an operator 170 of the non-automotive entity 140, or in the case of a wearable device, the non-automotive entity 140 her/himself, of the presence of the object 160. In one or more arrangements, as set forth below, the object identification system 100 can determine tracking information, for example, a movement of the object 160, etc., based at least in part on the acquired data from the vehicle-equipped detachable sensors 130. In this case, the object identification system 100 can output a tracking signal to the mobile device 150 corresponding to the movement.

As an example, the object identification system 100 of FIG. 1 illustrates the non-automotive entity 140, for example, an all-terrain vehicle (ATV), with the vehicle-equipped detachable sensor 130, e.g., the LIDAR sensor 134, mounted to the non-automotive entity 140. Further, the object identification system 100 receives a selected object type, for example, a “bear,” from the mobile device 150. The selected object type may have been entered into the mobile device 150 by the operator 170 of the non-automotive entity 140 via, e.g., an application running on the mobile device 150. The vehicle-equipped detachable sensor 130 detects not only the object 160 matching the selected object type, i.e., the bear, but also other objects 180 in the environment around the non-automotive entity. In one arrangement, the acquired data from the vehicle-equipped detachable sensor 130 is shared wirelessly with the mobile device 150, and the object identification system 100 notifies the operator 170 of the presence of the object 160 via a message output to the mobile device 150. For example, if the object 160 matching the selected object type was not present in the environment around the non-automotive entity 140, the object identification system 100 would not notify the operator 170, even though other objects 180 may have been detected by the object identification system 100, e.g., a rock and a tree as shown in FIG. 1.

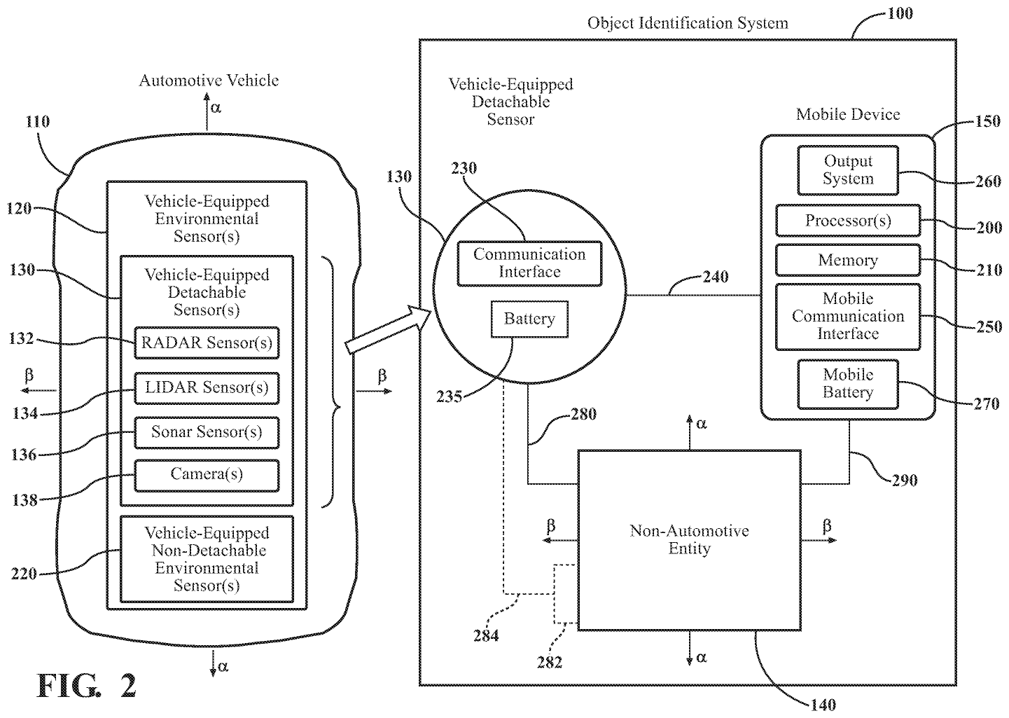

FIG. 2 is a block diagram of the automotive vehicle 110 and the object identification system 100 of FIG. 1. The automotive vehicle 110 may be any form of motorized, electrical or hybrid transport, e.g., a car, truck, SUV, etc., that incorporates at least one of the vehicle-equipped environmental sensors 120 configured as the vehicle-equipped detachable sensor 130. It should be appreciated that not all the various elements required for operation of the automotive vehicle 110 are shown in FIG. 2. Only the elements of the automotive vehicle 110 that are pertinent to the various embodiments of the object identification system 100 will be discussed herein.

The automotive vehicle 110 may include the one or more vehicle-equipped environmental sensors 120. The vehicle-equipped environmental sensors 120 are configured to acquire, and/or sense driving environment data. “Driving environment data” includes data or information about the external environment in which the automotive vehicle 110 is located or one or more portions thereof. In one or more arrangements, the vehicle-equipped environmental sensors 120 can be configured to monitor in real-time. As used herein, the term “real-time” means a level of processing responsiveness that a system senses as sufficiently immediate for a particular process or determination to be made, or that enables a processor to keep up with some external process. It will be understood that in various embodiments of the object identification system 100, it may not be necessary for the automotive vehicle 110 to have all of the vehicle-equipped environmental sensors 120 shown in FIG. 2.

The automotive vehicle 110 may include the one or more vehicle-equipped environmental sensors 120 that can be detached from automotive vehicle 110 (hereinafter referred to as “vehicle-equipped detachable sensors 130”). As shown in FIG. 2, for example, the vehicle-equipped detachable sensors 130 can include one or more radar sensors 132, one or more LIDAR sensors 134, one or more sonar sensors 136, and one or more cameras 138. Further, the automotive vehicle 110 can have additional sensors, including additional vehicle-equipped environmental sensors 120 configured as vehicle-equipped detachable sensors 130 now known or later developed, to those shown in FIG. 2, and it will be understood that the embodiments of the object identification system 100 are not limited to the specific vehicle-equipped detachable sensors 130 described herein. Furthermore, the vehicle-equipped detachable sensors 130 can be mounted internally within or mounted externally to the automotive vehicle 110.

The automotive vehicle 110 may include vehicle-equipped non-detachable environmental sensors 220 that are not configured as vehicle-equipped detachable sensors 130. An example of the vehicle-equipped non-detachable environmental sensors 220 may be the vehicle-equipped environmental sensors 120 that are not structured to be detached from the automotive vehicle 110, e.g., camera(s), LIDAR sensor(s), radar sensor(s), and/or sonar sensor(s). In other words, not all of the vehicle-equipped environmental sensors 120 may be configured as vehicle-equipped detachable sensors 130.

The non-automotive entities 140 of FIGS. 1 and 2 are any form of transport, for example, non-motorized, motorized, electric, hybrid, etc., all of which are not automotive vehicles 110, that may benefit from the additional capabilities realized by the object identification system 100, i.e., environmental object identification around the non-automotive entity 140 and associated notification as a result of the objects 160 identified as matching the selected object type received by the mobile device 150. For example, different types of non-automotive entities 140 may include, e.g., bicycles, tricycles, tandem bicycles, wheelchairs, skateboards, scooters, motorcycles, ATVs, boats, jet skis, three or more wheeled motorized vehicles, snowmobiles, Segways, golf carts, wagons, aerial drones, etc. As set forth above, the non-automotive entity 140 may be a user that adapts the vehicle-equipped detachable sensor 130 as a wearable device. The non-automotive entity 140 may include other vehicle-equipped sensors that are not structured to be detached and mounted elsewhere (not shown), e.g., cameras, radar sensors, etc.

The vehicle-equipped detachable sensors 130 may not be required for operation of the automotive vehicle 110. However, the vehicle-equipped detachable sensors 130 may be required for proper operation. For example, the automotive vehicle 110 operation may be impaired without the vehicle-equipped detachable sensors 130 installed. In some cases, the automotive vehicle 110 may not operate unless the vehicle-equipped detachable sensors 130 are reattached to the automotive vehicle 110 and functioning properly. Each of the vehicle-equipped detachable sensors 130 described herein are structured to be detached from the automotive vehicle 110 and mounted to the non-automotive entity 140 when the automotive vehicle 110 is not in use or not utilizing the vehicle-equipped detached sensor functionality. Typically, the differences between the vehicle-equipped detachable sensor 130 and the comparable vehicle-equipped non-detachable environmental sensor 220 are, for example, the mechanical ability of the vehicle-equipped detachable sensor 130 to be detached from the automotive vehicle 110 and the ability of the vehicle-equipped detachable sensor 130 to communicate with the mobile device 150. Otherwise, the two comparable sensors 130, 220 can function identically for their intended purposes.

In one or more arrangements, the vehicle-equipped detachable sensors 130 can include the one or more radar sensors 132. The radar sensors 132 can be any device, component and/or system that can detect a dynamic and/or stationary object using at least in part radio signals. The radar sensors 132 can be configured to detect the presence of one or more objects in a portion of the environment around the automotive vehicle 110, the position of detected objects relative to the automotive vehicle 110, the distance between each of the detected objects and the automotive vehicle 110 in one or more directions (e.g. in a longitudinal direction α of the automotive vehicle 110, a lateral direction β of the automotive vehicle 110, as shown in FIG. 2, and/or other direction(s)), the elevation of each of the detected objects, the speed of each of the detected objects, and/or a movement of each of the detected objects. The radar sensors 132, or data obtained thereby, can determine or be used to determine the speed, position, and/or orientation of objects in the environment around the automotive vehicle 110. The radar sensors 132 can have three-dimensional coordinate data associated with the objects.

In one or more arrangements, the vehicle-equipped detachable sensors 130 can include the one or more LIDAR sensors 134. The LIDAR sensors 134 can be any device, component and/or system that can detect a dynamic and/or stationary object using at least in part electromagnetic signals. In one or more arrangements, the electromagnetic signals can be laser signals. The LIDAR sensors 134 can include a laser source and/or laser scanner configured to emit a laser signal and a detector configured to detect reflections of the laser signal. The LIDAR sensors 134 may be configured to operate in a coherent or an incoherent detection mode.

The LIDAR sensors 134 can be configured to detect the presence of one or more objects in a portion of the environment around the automotive vehicle 110, the position of each of the detected objects relative to the automotive vehicle 110, the distance between each of the detected Objects and the automotive vehicle 110 in one or more directions, the elevation of each of the detected objects, the speed of each of the detected objects, and/or the movement of each of the detected objects.

In one or more arrangements, the vehicle-equipped detachable sensors 130 can include the one or more sonar sensors 136. The sonar sensors 136 can be any device, component and/or system that can detect a dynamic and/or stationary object using at least in part sound signals. For example, the sonar sensor 136 actively sends out a high-frequency sound pulse and then determines the time for the echo of the sound to reflect back. The sonar sensors 136 can be configured to detect multiple objects in a portion of the environment around the automotive vehicle 110, the position of each of the detected objects relative to the automotive vehicle 110, the distance between each of the detected objects and the automotive vehicle 110 in one or more directions, the speed of each of the detected objects, and/or the movement of each of the detected objects.

In one or more arrangements, the vehicle-equipped detachable sensors 130 can include the one or more cameras 138. The cameras 138 can be any device, component, and/or system that can capture visual data. The visual data can include video and/or image information/data. The visual data can be in any suitable form. In one or more arrangements, visual data can include heat signatures, thermal images, and/or thermal video of a portion of the environment around the automotive vehicle 110. The cameras 138 can be configured to detect multiple objects relative to the automotive vehicle 110. The cameras 138 may be arranged to determine a distance of each of the detected objects relative to the automotive vehicle 110 by, e.g., by a processor using triangle similarity techniques in conjunction with pixel measurements of a captured image. The cameras 138 may also be arranged to determine a speed of the detected object, e.g., by a processor tracking the determined distance over time.

The cameras 138 can be any suitable type of camera. For instance, the cameras 138 can be high resolution cameras, high dynamic range (HDR) cameras, infrared (IR) cameras, and/or thermal imaging cameras.

The vehicle-equipped detachable sensor 130 includes a communication interface 230 configured to communicate with the mobile device 150. In other words, the vehicle-equipped detachable sensor 130 is configured to wirelessly communicate with the mobile device 150. The communication interface 230 may be configured for wired and/or wireless communication with the mobile device 150 via a first link 240 and may be implemented by any number of communication protocols such as Ethernet, the Controller Area Network (CAN) protocol, Wi-Fi, the Local Interconnect Network (UN) protocol, Bluetooth®, Bluetooth® Low Energy, the Universal Serial Bus (USB) protocol etc.

In one or more arrangements, the vehicle-equipped detachable sensor 130 may include a battery 235 to power components of the vehicle-equipped detachable sensor 130. The battery 235 may be a rechargeable lithium-ion battery, or the like. In other arrangements, the vehicle-equipped detachable sensor 130 may not include the battery 235 and receive power from a mobile battery 270 of the mobile device 150 via the first link 240, as set forth below.

The mobile device 150 includes devices that are configured to communicate with the vehicle-equipped detachable sensor 130 in a wired and/or wireless fashion, as set forth below. The mobile device 150 may be mounted to the non-automotive entity 140, as shown in FIG. 1, or carried by the operator 170 of the non-automotive entity 140. The mobile device 150 may be, for example, a smart phone, a tablet, phablets, etc., or any other mobile device 150 that may be mounted to the non-automotive entity 140 and/or be able to be carried by the operator 170. The mobile device 150 may be, e.g., a smart display, that is configured to communicate with the vehicle-equipped detachable sensors 130 and mounted to the non-automotive entity 140. Alternatively, or in addition, the mobile device 150 may be an existing, e.g., integrated, display of the non-automotive entity 140 that is configured to communicate with the vehicle-equipped detachable sensors 130. For example, the existing display of the non-automotive entity 140 may pair, e.g., wirelessly connect via Bluetooth technology, with the vehicle-equipped detachable sensor 130 via the communications interface 230.

The components of the mobile device 150, in one embodiment, include a mobile communication interface 250, an output system 260, the mobile battery 270, one or more processors 200 and a memory 210. The processor(s) 200 and the memory 210 will be discussed in greater detail below.

The mobile communication interface 250 facilitates wired or wireless communication between the components of the mobile device 150 and the vehicle-equipped detachable sensors 130. The mobile communication interface 250 may be programmed to communicate in accordance with any number of wired or wireless communication protocols. For instance, the mobile communication interface 250 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, Wi-Fi, the Local Interconnect Network (LIN) protocol, the Universal Serial Bus (USB) protocol, etc. As discussed in greater detail below, in one embodiment, the mobile communication interface 250 receives data from the vehicle-equipped detachable sensor 130 and passes that data to the processor(s) 200, stores that data in the memory 210, or both.

The output system 260 of the mobile device 150 is operatively connected to the processor(s) 200 of the mobile device 150. The output system 260 includes any device, component, or arrangement or groups thereof that enable information/data to be presented to the operator 170 or the non-automotive entity 140, the wearable device user. For example, the output system 260 may include a mobile display, mobile speakers, haptic vibration motors, a light emitting diode (LED) flash, etc. As use herein, operatively connected can include direct or indirect connections, including connections without direct physical contact.

The mobile battery 270 provides power to one or more components of the mobile device 150. The mobile battery 270 may be a rechargeable lithium-ion battery, or the like. In one embodiment, the mobile battery 270 supplies power via one or more wires to the vehicle-equipped detachable sensors 130 via the first link 240, as set forth above. In yet another arrangement, the vehicle-equipped detachable sensor 130 may include the battery 235 and the mobile device 150 may include the mobile battery 270. In this case, either battery 235, 270 may recharge the other.

The object identification system 100 includes a second link 280 between the vehicle-equipped detachable sensor 130 and the non-automotive entity 140 for each vehicle-equipped detachable sensor 130 of the object identification system 100. The second link 280 may include, for example, a mechanical device that mounts the vehicle-equipped detachable sensor 130 to the non-automotive entity 140, e.g., straps, fasteners, zip-ties and/or Velcro®, etc. The second link 280 may include, for example, a mechanical device that receives the vehicle-equipped detachable sensor 130 and directly mounts it to the non-automotive entity 140. That is, the second link 280 may be a mechanical device that adapts the vehicle-equipped detachable sensor 130 as a wearable device so that the non-automotive entity 140 may wear the vehicle-equipped detachable sensor 130. The mechanical device of the second link 280 may be, for example, a belt having compartments to receive the vehicle-equipped detachable sensor 130, pockets that may receive the vehicle-equipped detachable sensor 130, hooks attached to clothing of the non-automotive entity 140 to receive the vehicle-equipped detachable sensor 130, etc. As set forth below, the one or more second links 280 may include a wired or wireless link that facilitates communication between the communication interface 230 of the vehicle-equipped detachable sensors 130 and the non-automotive entity 140.

In one or more arrangements, the vehicle-equipped detachable sensor 130 may be mounted to the non-automotive entity 140 indirectly. That is, the object identification system 100 may include an intermediate device 282 and an intermediate mechanical link 284 both of which are between the non-automotive entity 140 and the vehicle-equipped detachable sensor 130, as shown in hidden lines in FIG. 2. In this case, the vehicle-equipped detachable sensor 130 is mounted to the intermediate device 282 via the intermediate mechanical link 284 and the intermediate device 282 is directly mounted to the non-automotive entity 140. For example, the intermediate device 282 may be a helmet that is mounted directly to the head of the non-automotive entity 140, a gun that is held directly by hands of the non-automotive entity 140, skis that extend directly from feet of the non-automotive entity 140, a backpack that protrudes directly from a back of the non-automotive entity 140, etc. The intermediate mechanical link 284 may be any suitable fastening device, e.g., clips, ties, bands, etc. Further, for the case where the object identification system 100 includes one or more vehicle-equipped detachable sensors 130, the object identification system 100 may include the second link 280 directly mounting the one or more vehicle-equipped detachable sensors 130 to the non-automotive entity 140, the intermediate mechanical link 284 indirectly mounting the one or more vehicle-equipped detachable sensors 130 to the non-automotive entity 140 or both.

The object identification system 100, in one arrangement, includes a third link 290 between the mobile device 150 and the non-automotive entity 140. The third link 290 may include a mechanical device that receives the mobile device 150 and directly mounts it to the non-automotive entity 140, e.g., as shown in FIG. 1. The mechanical device of the third link 290 may be, for example, a pocket attached to the non-automotive entity 140 that may receive the mobile device, a Velcro strap that is attached to the mobile device 150 and an arm of the non-automotive entity 140, etc. In another arrangement, the third link 290 may simply be a hand of the non-automotive entity 140 that carries the mobile device 150, which acts as a direct method of mounting the mobile device 150 to the non-automotive entity 140. In another arrangement, the mobile device 150 may be indirectly mounted to the non-automotive entity 140 via an intermediate mechanical link 284 between the mobile device 150 and an intermediate device 282 that is mounted to the non-automotive entity 140 (not shown). In yet another arrangement the third link 290 may include, for example, a wired and/or wireless communication link between the mobile communication interface 250 of the mobile device 150 and the non-automotive entity 140.

The second and third links 280, 290 may include, for example, one or more connectors (not shown) that electrically couple and mechanically mount both the vehicle-equipped detachable sensor 130 and the mobile device 150 to the non-automotive entity 140. For example, the second and third links 280, 290 may be one or more sockets (not shown) that receive and mechanically mount the vehicle-equipped detachable sensor 130 and the mobile device 150 to the non-automotive entity 140 while providing, e.g., a wired interface that facilitates electrical communications between the vehicle-equipped detachable sensor 130 and the mobile device 150, i.e., incorporates the first link 240.

The vehicle-equipped detachable sensors 130 are structured to be detached from the automotive vehicle 110 and mounted to the non-automotive entity 140 when the automotive vehicle 110 is not in use or not utilizing the vehicle-equipped detached sensor functionality. Accordingly, the vehicle-equipped detachable sensors 130 are structured such that they may be man-portable, i.e., the vehicle-equipped detachable sensors 130 may be extracted from, e.g., a housing cavity, by a single human user and may be carried by a single human user without assistance of devices. The vehicle-equipped detachable sensors 130 are also structured to be mounted to the non-automotive entity 140. For example, the vehicle-equipped detachable sensors 130, once removed from the automotive vehicle 110, are of reasonable size and weight to mount to the various types of non-automotive entities 140, e.g., the size of a deck of cards and weighing less than one kilogram.

In arrangements in which the object identification system 100 includes a plurality of vehicle-equipped detachable sensors 130, the plurality of vehicle-equipped detachable sensors 130 can be distributed about the non-automotive entity 140 in any suitable manner. The vehicle-equipped detachable sensors 130 can work independently from each other or in combination with each other. In such case, the two or more vehicle-equipped detachable sensors 130 can form a sensor network.

The vehicle-equipped detachable sensors 130, which are configured to acquire and/or sense driving environment data as set forth above, are also configured to acquire and/or sense driving environment data around the environment of the non-automotive entity 140 or portions thereof when the vehicle-equipped detachable sensors 130 are mounted to the non-automotive entity 140. For instance, the vehicle-equipped detachable sensors 130 can be configured to acquire data of at least a forward portion and/or at least a rearward portion of the environment around the non-automotive entity 140. For example, the vehicle-equipped detachable sensors 130 can monitor a forward portion along a longitudinal direction α of the non-automotive entity 140 in front of the non-automotive entity 140, and/or monitor the rearward portion along the longitudinal direction α, of the non-automotive entity 140 behind the non-automotive entity 140, as shown in FIG. 2.

Additionally, or alternatively, the vehicle-equipped detachable sensors 130 can be configured to acquire data of at least a side portion of the environment around the non-automotive entity 140 when the vehicle-equipped detachable sensors 130 are mounted to the non-automotive entity 140. The side portion can be, for example, a portion of the environment that is located between the forward portion and the rearward portion of the non-automotive entity 140. For example, the vehicle-equipped detachable sensors 130 can be configured to monitor a left side and/or a right side portion along a lateral direction β of the non-automotive entity 140, as shown in FIG. 2.

In either case, the object identification system 100 is implemented to perform methods and functions as disclosed herein relating to extending the use of temporarily idle vehicle-equipped detachable sensors 130 to acquire data about one or more objects in an environment around a non-automotive entity 140 and provide notification of objects 160 matching the selected object type received by the mobile device. In some embodiments, the object identification system 100 determines tracking information about the object 160 and provides notification via the mobile device corresponding to the tracking information. The noted functions and methods will become more apparent with a further discussion of the figures.

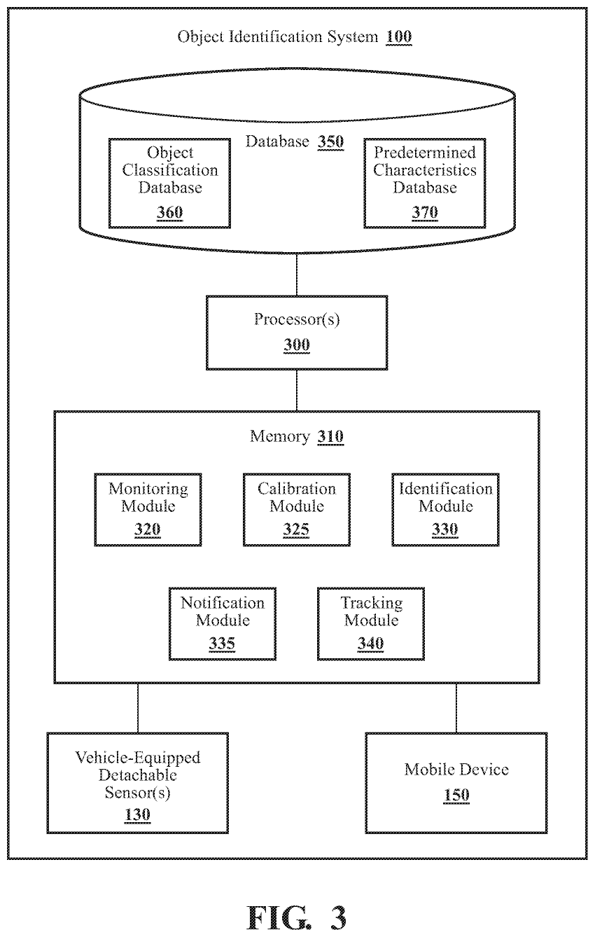

FIG. 3 illustrates one embodiment of the object identification system 100 of FIGS. 1 and 2 that provides one or more benefits of environmental object detection, notification, and in one or more arrangements, control for a type of non-automotive entity 140, e.g., a bicycle, motorcycle, ATV, a wearable device user, etc. The object identification system 100 can include one or more processors 300. The processor(s) 300 can be any component or group of components that are configured to execute any of the processes described herein or any form of instructions to carry out such processes or cause such processes to be performed. Examples of suitable processor(s) 300 can include microprocessors, microcontrollers, digital signal processors, and other circuitry that can execute software. Further examples of suitable processor(s) 300 include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 300 can include at least one hardware circuit (e.g., an integrated circuit) configured to carry out instructions contained in program code. In arrangements in which there is a plurality of processors 300, such processors can work independently from each other or one or more processors can work in combination with each other.

The object identification system 100 can include a computer readable medium. In one or more arrangements, the computer readable medium can be a memory 310. Additionally, in one embodiment, the memory 310 stores a monitoring module 320, a calibration module 325, an identification module 330, a notification module 335, and a tracking module 340. The memory 310 is a random-access memory (RAM), read-only memory (ROM), a hard-disk drive, an external hard-disk drive, a flash memory, or other suitable memory for storing the modules 320, 325, 330, 335, and 340. The modules 320, 325, 330, 335, and 340 are, for example, computer-readable instructions that when executed by the processor(s) 300 cause the processor(s) 300 to perform the various functions of the object identification system 100 disclosed herein. In one or more arrangements, the memory 310 can be a component of the processor(s) 300. In one or more arrangements, the memory 310 can be operatively connected to the processor(s) 300 and used thereby.

In one or more arrangements, the vehicle-equipped detachable sensors 130 may include the one or more of the processors 300 and/or the memory 310. That is, the vehicle-equipped detachable sensors 130 may be considered “smart sensors.” The processor(s) 300 and the memory 310 of the object identification system 100 may be completely contained within the vehicle-equipped detachable sensors 130, the mobile device 150 or be distributed among the mobile device 150 and vehicle-equipped detachable sensors 130. The processor(s) 200 and the memory 210 may be a part of the object identification system 100, the object identification system 100 may include separate processor(s) and memory from the processors(s) 200 and the memory 210, or the object identification system 100 may access the processor(s) 200 and the memory 210 through a data bus or another communications path. As an example of a distributed object identification system 100, the vehicle-equipped detachable sensor 130 may include one of the processor(s) 300 and the memory 310 executing and storing the monitoring module 320, respectively and the mobile device 150 may include one of the processor(s) 300 and the memory 310 executing and storing the identification module 330 and the notification module 335, respectively.

In either case, in one or more arrangements of the object identification system 100, the vehicle-equipped detachable sensors 130 may include at least one of the one or more processors 300 and the memory 310 and the mobile device 150 may include at least one of the one or more processors 300 and the memory 310. The processor(s) 200 and the processor(s) 300, may be operatively connected to each other and may process any portion of the modules 320, 325, 330, 335, and 340 in any combination. The memory 210 and the memory 310 may be operatively connected to each other and may store any portion of the modules 320, 325, 330, 335, and 340 in any combination.

With continued reference to FIG. 3, in one embodiment, the monitoring module 320 includes instructions that function to control the processor(s) 300 to acquire data from vehicle-equipped detachable sensors 130 of the environment around the non-automotive entity 140 when the vehicle-equipped detachable sensors 130 are mounted to the non-automotive entity 140. The data may be of the form, e.g., image data from the cameras 138, three-dimensional reflective data (from, e.g., the radar sensors 132, the LIDAR sensors 134, the sonar sensors 136), etc. Specifically, the monitoring module 320 collects data acquired from the vehicle-equipped detachable sensors 130 and stores the data in a database 350.

The monitoring module 320, in one or more arrangements, configures the vehicle-equipped detachable sensors 130 to detect objects associated with the acquired data in the environment around the non-automotive entity 140. Detecting objects can include, for example, determining, assessing, monitoring, measuring, quantifying and/or sensing, directly or indirectly, the presence of one or more dynamic and/or stationary objects in the environment around the non-automotive entity 140. Additionally, the monitoring module 320 can determine if the detected object is small enough such that its presence in the environment around the non-automotive entity 140 is insignificant and may disregard the detected object.

The calibration module 325, in one embodiment, includes instructions that function to control the processor(s) 300 to calibrate the vehicle-equipped detachable sensor 130 once mounted on the non-automotive entity 140. Typically, when the vehicle-equipped detachable sensor 130 is detached from the automotive vehicle 110 and mounted to the non-automotive entity 140, the vehicle-equipped detachable sensor 130 may require calibration. That is, the vehicle-equipped detachable sensor 130 may need to be configured to a mounting location on the non-automotive entity 140 so that the acquired data from the monitoring module 320 is representative of the environment around the non-automotive entity 140.

In one embodiment, the calibration module 325 calibrates the vehicle-equipped detachable sensor 130 to the mounting location on the non-automotive entity 140 by accessing and using acquired data from the monitoring module 320 and mounting location parameters associated with the mounting location of the vehicle-equipped detachable sensor 130 on the non-automotive entity 140. For example, the calibration module 325 may require values of parameters for, e.g., a measured height at which the vehicle-equipped detachable sensor 130 is mounted with respect to the ground, a measured distance a known object is from the vehicle-equipped detachable sensor 130 once mounted on the non-automotive entity 140, etc. The calibration module 325 may receive values of the mounting location parameters from, e.g., the operator 170 entering the value into the mobile device 150 (e.g., a calibration application running on the mobile device 150), etc. Thus, the calibration module 325, in one arrangement, calibrates the vehicle-equipped detachable sensor 130 to a portion of the environment around the non-automotive entity 140 based at least in part on mounting location parameters associated with the mounting location of the vehicle-equipped detachable sensor 130 on the non-automotive entity 140.

In one arrangement; the calibration module 325 may determine the measured height and the measured distance directly, as is known. In other words, the vehicle-equipped detachable sensor 130 may be capable of automatic calibration. In this instance, the calibration module 325 includes instructions that function to control the processor(s) 300 to access other sensing components of the mobile device 150 (not shown) to assist in providing the necessary values of the mounting location parameters to the calibration module 325, e.g., the mounting height, the measured distance, the orientation of the vehicle-equipped detachable sensor 130 with respect to the non-automotive entity 140, etc. The calibration module 325 may require any suitable type of mounting location parameters to calibrate the vehicle-equipped detachable sensor 130 to the mounting location on the non-automotive entity 140, e.g., a mounting angle from the longitudinal direction α of the non-automotive entity 140, a mounting angle from the lateral direction β of the non-automotive entity 140, a mounting angle from ground, etc. Further, the calibration module 325 may access and use acquired data from the monitoring module 320, and/or request that the monitoring module 320 acquire new data, e.g., when the measured distance of the known object has changed, when the vehicle-equipped detachable sensor 130 needs to be re-calibrated as determined by the calibration module 325, the operator 170 or the non-automotive entity, i.e., the wearable device user, etc.

The calibration module 325 may store a calibration that includes the mounting location parameters in the memory 210 of the mobile device 150 and/or the memory 310 of the vehicle-equipped detachable sensor 130, if the vehicle-equipped detachable sensor 130 is so equipped. The calibration may be indexed by, e.g., a sensor type, a mounting location, a calibration date, etc., so that calibration module 325 can retrieve and use the calibration in lieu of re-calibrating the same vehicle-equipped detachable sensor 130 to the same mounting location.

Alternatively, the vehicle-equipped detachable sensor 130 may not need calibration if it is utilized in a specific manner. For example, the vehicle-equipped detachable sensor 130 may not require calibration if it is mounted on the non-automotive entity 140 at a certain height from the ground. As another example, the vehicle-equipped detachable sensor 130 may not require calibration if it is being used to sense objects that are within a specified distance from the from the vehicle-equipped detachable sensor 130, e.g., 20 meters, etc.

The identification module 330, in one embodiment, includes instructions that function to control the processor(s) 300 to identify, from the acquired data, an object 160 based on a selected object type received from the mobile device. As set forth above, the selected object type may have been entered into the mobile device 150 by the operator 170 of the non-automotive entity 140, or in the case of a wearable device, the non-automotive entity 140 her/himself, via, e.g., an application running on the mobile device 150.

There may be one or more selected object types describing the one or more objects 160 and there may be more than one object 160 fulfilling the selected object type designation. For example, the operator 170 may enter into to the mobile device, e.g., via an application, the selected object types “brown” and “animal.” In this case, as set forth immediately below, the identification module 330 can identify, from the acquired data, various objects 160 matching these selected object types in the environment around the non-automotive entity 140, e.g., a brown squirrel, a brown bear, a brown bird, etc.

With continued reference to FIG. 3, the database 350 is, for example, an electronic data structure stored in the memory 310 or another electronic data store and is configured with routines that can be executed by the processor(s) 300 for analyzing stored data, providing stored data, organizing stored data, and so on. Thus, in one embodiment, the database 350 stores data used/provided by modules 320, 325, 330, 335, and 340 in executing various functions. The vehicle-equipped detachable sensors 130 can be operatively connected to the processor(s) 300, the database 350, the memory 310, and/or any other modules stored in the memory 310.

In one or more arrangements, the database 350 can include an object classification database 360. The object classification database 360 can include data corresponding to the classification of various objects. For example, the object classification database 360 can include data corresponding to features of various objects found in the environment around the non-automotive entity 140. Such features can be in the form of an image stored in the object classification database 360, a typical reading from the one or more vehicle-equipped detachable sensors 130 indicative of the type of object, and/or any other form of data useful for classifying objects. Examples of the various objects include, for example, vehicles; motorcycles, trees, pedestrians, bicyclists, animals, roadway signs, barricades, rivers, bridges, or any other objects typically found in the environment around the non-automotive entity 140.

Furthermore, the object classification database 360 may include specific characteristics regarding the type of object, for example, sedan, SUV, convertible, pick-up truck, mountain bicycle, racing bicycle, motocross motorcycle, street motorcycle, male or female pedestrian, large bear, brown bear, etc. The object classification database 360 may include object brand types, for example, Toyota vehicle, Lexus vehicle, Yamaha motorcycle, Kodiak bear, etc., and object model types, for example, Toyota Camry, Lexus IS, Yamaha Aerox 4, etc. The object classification database 360 may include any other level of detail that can distinctly classify the object.

Accordingly, the identification module 330, in one embodiment, includes instructions to compare the features stored in the object classification database 360 to data captured from the vehicle-equipped detachable sensors 130. For example, an image of an animal stored on the object classification database 360 can be compared to images of the detected objects in the environment around the non-automotive entity 140 captured from, e.g., the camera 138. Such comparison can be performed by image processing software. The image processing software can be implemented by the identification module 330. Responsive to the comparison of the animal being substantially the same as the detected object, the identification module 330 can determine that the detected object is an animal.

Additionally, or alternatively, the object classification database 360 can store data readings that are typical of the particular type of objects. For example, the object classification database 360 can store data from a typical LIDAR sensor reading indicative of a bear. Responsive to the comparison of the typical LIDAR sensor reading being substantially the same as the detected object in the environment around the non-automotive entity 140 as detected by the LIDAR sensor 134, the identification module 330 can determine that the detected object is a bear. Although the previous two examples have been provided for purposes of clarity, any types of data can be stored on the object classification database 360 for comparison to data obtained via the vehicle-equipped detachable sensors 130, “Substantially the same” as mentioned above can be, for example, within one standard deviation, within half a standard deviation, within a quarter of a standard deviation, etc., or any other suitable method for determining similarities between images (from, e.g., the camera 138), reflective data (from, e.g., the radar sensors 132, the LIDAR sensors 134, the sonar sensors 136), etc. The determination of “substantially the same” may, for example, be different for comparisons between images than that of reflective type sensor data. As a result of the comparison, the detected object in the environment around the non-automotive entity 140 can be classified by the identification module 330.

The identification module 330 includes instructions, in one arrangement, to cross-reference the selected object type with the data stored in the object classification database 360 to determine, for example, a representative image corresponding the selected object type. The selected object type may be, for example, features of various on-road and off-road objects described above and/or or any other form of data useful for specifying object types. Using the classification methods described above, the identification module 330 can compare the representative image corresponding to the selected object type to the detected object and determine that the representative image is substantially the same as the detected object. In determining that the representative image is substantially the same as the detected object, the identification module 330 determines that the detected object is identified as the object 160 matching the selected object type. Thus, the identification module 330 can classify a detected object by comparing data stored in the object classification database 360 to the detected object, as well as identify the detected object as matching the selected object type by comparing data stored in the object classification database 360 that represents the stored object type via a cross-referencing operation to the detected object.

The notification module 335, in one embodiment includes instructions that function to control the processor(s) 300 to output at least one notification signal to the mobile device 150 in response to identifying the object 160 from the acquired data. In other words, the notification module 335 outputs at least one notification signal to the mobile device 150 when the identification module 330 identifies the object 160, from the acquired data, matching the selected object type criterion in the environment around the non-automotive entity 140. Conversely, the notification module 335 may not provide notification when the detected objects do not match the selected object type.

The notification module 335 may tailor the notification signal to provide one or more visual, audio and/or haptic perceptible effects. The notification signal parameters may be controlled, for example, by user input via an application running on the mobile device 150. Accordingly, the notification signal may have multiple components, e.g., a visual warning message including audio beeps, an audio warning message including haptic vibration information, etc. As set forth below, the notification module 335 may output at least one tracking signal in response to, for example, the movement of the object 160.

Once the notification signal is output to the mobile device 150, the processor(s) 200 of the mobile device may parse the notification signal and direct its components to the appropriate output system 260 of the mobile device 150, e.g., the mobile display, mobile speakers, haptic vibration motors, the light emitting diode (LED) flash, etc., as discussed above.

The tracking module 340, in one or more arrangements, includes instructions that function to control the processor(s) 300 to determine tracking information about the object 160 once it has been identified. The tracking information may include at least one of a position of the object 160, a velocity of the object 160, an elevation of the object 160, a current trajectory of the object 160 and a predicted trajectory of the object 160. The determination of the tracking information is based at least in part on the acquired data. Alternatively, or in addition, the determination of the predicted trajectory of the object 160 may be based on a classification of the object 160, as described in greater detail below.

The tracking module 340 may determine the tracking information using any suitable method. For example, the tracking module 340 may determine the position and dynamic information, e.g., speed, acceleration, deceleration, etc., of the object 160 directly from acquired data of the vehicle-equipped detachable sensor 130 (e.g., the radar sensor 132, the LIDAR sensor 134, the sonar sensor 136) or indirectly, for example, by comparing changes in the position data of the object 160 over time from the camera 138 images. The tracking module 340 may determine that the object 160 is a specific distance relative to the non-automotive entity 140. The tracking module 340 may determine the current trajectory and/or the predicted trajectory, i.e., future trajectory, of the object 160 (if any) from the instant direction, acceleration/deceleration and velocity of the object 160. The predicted trajectory of the object 160 may, for example, be based on the continuation of the current direction and the movement of the object 160. The object 160 may have suddenly changed course, and the predicted travel trajectory may be based on the continuation and the new direction and the movement of the object 160. The position and dynamic information, which may include direction and orientation of the object 160, may be determined by the tracking module 340 from any type of environmental or contextual information collected by the vehicle-equipped detachable sensors 130. Alternatively, the tracking module 340 may determine, for example, the position of the object 160 relative to the non-automotive entity 140, the current and predicted trajectories of the object 160 and/or the location of the object relative to the non-automotive entity 140 based on the data received from the navigation unit of the mobile device 150.

The tracking module 340 may incorporate a position, dynamic information, a current travel trajectory and/or a predicted travel trajectory of the non-automotive entity 140 when determining the tracking information of the object 160. The tracking module 340 may determine static and dynamic information regarding the non-automotive entity 140 in any suitable manner. For example, the tracking module 340 may determine the position, dynamic information and the trajectories in a similar fashion as determined for the object 160, as set forth above. The tracking information may be relative to the non-automotive entity 140 or absolute, i.e., a movement of the non-automotive entity 140 has been accounted for and the tracking information is relative to the environment around the non-automotive entity 140. Different calibrations determined by the calibration module 325 may affect the tracking information. The object 160 and/or the non-automotive entity 140 may be stationary at any time when the tracking module 340 is determining the tracking information.

Furthermore, in one arrangement, the tracking module 340 includes instructions to determine whether the object 160 comes within a predetermined distance of the non-automotive entity 140. The predetermined distance can be any suitable value, including, for example, about 20 feet or less, about 15 feet or less, about 10 feet or less, about 5 feet or less, about 4 feet or less, about 3 feet or less, about 2 feet or less or about 1 foot or less. The tracking module 340 may receive a value of the predetermined distance from a lookup table stored in the database 350 or from, e.g., the operator 170 or non-automotive entity 140, i.e., the wearable device user, entering the value into the mobile device 150 (e.g., an application running on the mobile device 150), etc.

Alternatively, or in addition, the tracking module 340, in one or more arrangements, also includes instructions to determine the predicted trajectory of the object 160 indirectly based on the classification of the object 160 via the object classification database 360, as set forth above, and an associated predetermined characteristic of the detected object 160, as explained immediately below.

In one or more arrangements, the database 350 further includes a predetermined characteristics database 370. The predetermined characteristics database 370 can include one or more predetermined characteristics for various types of detected objects that have been classified. The predetermined characteristics can be indicative of tendencies specific detected objects types have when moving and may be utilized by the tracking module 340 to determine the predicted trajectory of the object 160. For example, the predetermined characteristics for a type of detected object that has been classified, e.g., an ATV, may be: top speed, more aggressive as compared to the predetermined characteristics for a standard street motorcycle, tend to have higher speeds on pavement as compared to gravel, tend to travel closer to moving objects as compared to vehicles, etc. It should be noted that the present disclosure is not limited to this example. In fact, any way of profiling various types of detected objects that have been classified may be used in the predetermined characteristics database 370 and subsequently by the tracking module 340 in the determination of the predicted trajectory of the object 160. Additionally, different levels of profiling can be incorporated, including profiling based on the various classifications of the detected object, for example, type, brand, model, size, shape, color, gender, etc., and/or any other levels of profiling that could be used to differentiate tendencies of movement.

In either case, the tracking module 340, in one or more arrangements, can determine the static and dynamic information of the object 160 and the non-automotive entity 140 based on the acquired data, as set forth above, to ultimately determine tracking information of the object 160. Additionally, the predicted trajectory of the object 160 may be determined indirectly or the determination of the predicted trajectory of the object 160 from the acquired data may be enhanced by basing the determination on the predetermined characteristics for the detected object that has been classified, i.e., the detected object identified as the object 160 matching the selected object type.

The notification module 335, in one embodiment includes instructions that function to output at least one tracking signal to the mobile device 150 in response to determining the tracking information of the object 160. For example, the notification module 335 may output at least one tracking signal to the mobile device to inform the operator 170, or the non-automotive entity 140 that has adapted the vehicle-equipped detachable sensor 130 as a wearable device, of the position of the object 160, the velocity and derived acceleration/deceleration of the object 160, the elevation of the object 160, the current trajectory of the object 160 and/or a predicted trajectory of the object 160. It should be noted that the present disclosure is not limited to these examples.

The tracking signal may have multiple components such that a variety of perceptible content can be delivered to the operator 170 or the non-automotive entity 140, i.e., wearable device user, via the mobile device 150. The processor(s) 200 of the mobile device may parse the tracking signal and direct its components to the appropriate output system 260 of the mobile device 150. For example, the mobile device 150 may provide a visual marker representing the position of the object 160 relative to the non-automotive entity 140 on the mobile display accompanied by a haptic vibration, a directional arrow representing the predicted trajectory of the object 160 on the mobile display accompanied by the LED flash of the mobile device 150, a visual marker representing the elevation of the object 160 accompanied by audio beeps that change duration depending upon how close the object 160 is to the non-automotive entity 140, etc. The tracking signal parameters may be controlled, for example, by user input via an application running on the mobile device 150. In other words, the tracking information may be presented to the operator 170 or the non-automotive entity 140, i.e., wearable device user, via the mobile device, in such a manner that one can determine the static or dynamic behavior the object 160.

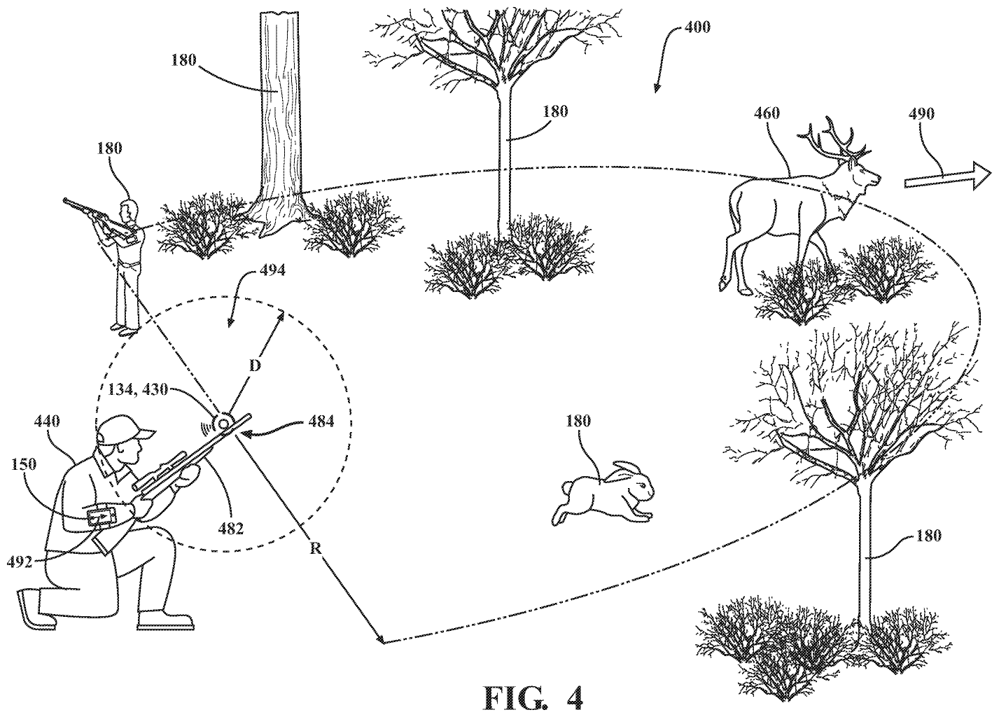

As an example of how the tracking module 340 operates, FIG. 4 will now be discussed. FIG. 4 illustrates an object identification system 400 where a non-automotive entity 440, such as a hunter, has adapted the vehicle-equipped detachable sensor 430, for example, the LIDAR sensor 134, as a wearable device. The vehicle-equipped detachable sensor 430 is indirectly mounted to the non-automotive entity 440 by mounting the vehicle-equipped detachable sensor 430 to an intermediate device 482, such as a rifle, via an intermediate mechanical link 484, e.g., a Velcro strap. The non-automotive entity 440 has entered a “buck” as the selected object type into the mobile device 150 via, e.g., an application running on the mobile device 150. The identification module 330 identifies the detected objects as the object 460 matching the selected object type. The identification module 330 disregards the other objects 180 detected, for example, another hunter 180 in the background, a tree 180 and a bunny 180, as shown in FIG. 4, The notification module 335 notifies the non-automotive entity 440 via the mobile device 150 of the presence of the object 460, e.g., by a haptic vibration. The tracking module 340 determines the tracking information of the object 160. As shown in FIG. 4, the tracking information includes, for example, the predicted trajectory 490 of the object 460. The predicted trajectory 490 may be determined directly from the acquired data and/or from predetermined characteristics of the object 460, i.e., the buck, stored in the predetermined characteristics database 370 for the detected and classified object identified as the object 460 matching the selected object type of “buck.” The notification module 335 outputs a tracking signal 492 to the mobile device 150 corresponding to the predicted trajectory of the object 460, for example, a marker of the buck with a directional arrow with respect to the hunter displayed on the mobile display and an accompanying haptic vibration indicating the buck is moving. It should be appreciated that more than one selected object type may be present in the environment around the non-automotive entity 440 and multiple tracking signals 492 can be output to the mobile device 150. Additionally, a scanning radius R of the vehicle-equipped detachable sensor 430 may be adjustable to, for example, conserve memory, limit a tracking area, etc. Consistent with all parameters, the scanning radius R may be entered into the mobile device 150 via, e.g., an application running on the mobile device 150.

With continued reference to FIG. 4, a predetermined distance D is associated with the non-automotive entity 440. The predetermined distance D may be a distance value entered into the mobile device 150 by non-automotive entity 440, i.e., wearable device user, and received by the tracking module 340, as set forth above. The predetermined distance D may correspond to a buffer zone 494, i.e., a three-dimensional sphere with radius D, around the non-automotive entity 440. The buffer zone 494 may represent a space where, in this case, the hunter, would feel uncomfortable if an object 460 were to penetrate the buffer zone 494. If the object 460 were to penetrate the buffer zone 494, the tracking module 340 may output a tracking signal to the mobile device 150 representing an encroachment of the buffer zone 494, e.g., an audible tone and visual warning message on the mobile display.

The object identification system 100 has various applications that extend the usage of the different types of vehicle-equipped detachable sensors 130. For example, a police officer may detach the vehicle-equipped detachable sensors 130, e.g., a thermal (infra-red) camera 138 responsible for detecting heat radiating objects in the dark while driving, after stopping the automotive vehicle 110 and starting a pursuit of a suspect on foot in the dark. The officer can enter the selected object type into the mobile device 150 and mount the thermal camera 138 directly to his/her vest to scan the environment around the officer, i.e., the non-automotive entity 140 has adapted the vehicle-equipped detachable sensor 140 as a wearable device. Notification of objects 160, in this case thermally radiating suspects matching the selected object type, can occur via the cell phone of the officer.

As another example, the vehicle-equipped detachable sensors 130, e.g., the LIDAR sensor 134, may be held directly by the non-automotive entity 140, i.e., the wearable device user. The wearable device user, for example, a parent, may scan a crowd of people looking for a selected object type, e.g., a child wearing a stripped shirt. The selected object types “child” and “stripped shirt” may be entered by the parent into their cell phone and the parent would be notified as to the presence of the child matching the selected object types. The cell phone may also display the current and/or predicted trajectory, i.e., the tracking information, of the child once the child has been identified. This example could be extended to finding lost articles, etc.

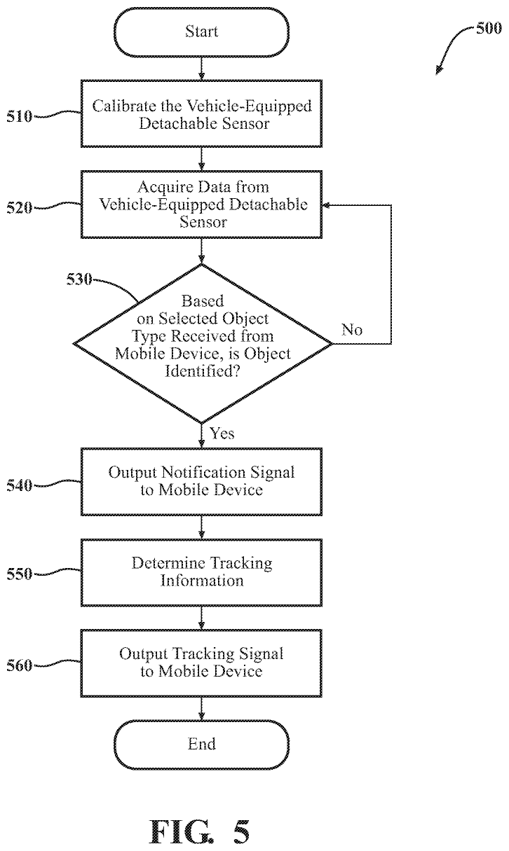

FIG. 5 illustrates a flowchart of a method 500 that is associated with extending the usage of the vehicle-equipped environmental sensors 120 from the automotive vehicle 110 to the non-automotive entity 140, 440, Method 500 will be discussed from the perspective of the object identification systems 100, 400 of FIGS. 1-4. While method 500 is discussed in combination with the object identification system 100, 400 it should be understood that the method 500 is not limited to being implemented within the object identification system 100, 400, but is instead one example of a system that may implement the method 500. The steps that are illustrated herein as part of the method 500 are not limited to this particular chronological order. Indeed, some of the steps may be performed in a different order than what is shown and/or at least some of the steps shown can occur simultaneously.

As an initial matter, it should be noted that prior to acquiring sensor data at block 520, the vehicle-equipped detachable sensor 130, 430 may need to be calibrated to a mounting location on the non-automotive entity 140, 440. Thus, the described method 500, in one embodiment, includes a calibration step that is performed by block 510 that generally occurs before block 520. However, the calibration step of block 510 may occur in parallel to the method 500. For example, the vehicle-equipped detachable sensor 130, 430 may need to be re-calibrated for whatever reason. Moreover, the calibration step of block 510 may not be necessary at all, as set forth above, and the method 500 starts at block 520.

At block 510, the calibration module 325, in one or more arrangements, may be accessed automatically when the vehicle-equipped detachable sensor 130, 430 is detached and mounted to the non-automotive entity 140, 440. For example, the calibration module 325 is automatically accessed by the object identification system 100, 400 when, e.g., the power to the vehicle-equipped detachable sensor 130, 430 is removed and restored upon detachment and mounting, the calibration module 325 determines that a re-calibration is needed (e.g., the current calibration is outdated), etc. In other arrangements, the calibration module 325 may be accessed manually via, e.g., a calibration application running on the mobile device 150 that receives mounting location parameters from the non-automotive entity 140, 440, etc. In either case, once the calibration module 325 is initiated, the calibration module 325 can recall a previous calibration indexed in the memory 310. The calibration module 325 can determine if a new calibration is needed, e.g., the calibration is outdated, mounting location parameters have changed, no calibration exists, etc. If calibration is needed, the calibration module 325 can access data acquired by the monitoring module 320, request that the monitoring module 320 acquired new sensor data, and/or obtain mounting location parameters, as set forth above. Once the calibration module 325 is completed with the calibration, i.e., configuring the vehicle-equipped detachable sensor 130, 430 to the mounting location on the non-automotive entity 140, 440, the calibration module 325 can index a new calibration and store the new calibration in the memory 310. The method 500 may then proceed to block 520.

At block 520 the monitoring module 320 acquires data from the vehicle-equipped detachable sensor 130, 430 and stores the data in the database 350. In general, the monitoring module 320 continuously acquires data in order to continually update a perception of the surrounding environment around the non-automotive entity 140, 440 when the vehicle-equipped detachable sensor 130, 430 is mounted to the non-automotive entity 140, 440. Thus, while the method 500 is discussed in a generally serial manner, it should be appreciated that the object identification system 100, 400 can execute multiple iterations of the method 500 in order to maintain awareness of the surrounding environment. Moreover, because certain aspects of the acquired data are temporal in nature (e.g., tracking of moving objects), the monitoring module 320 can continuously acquire data and maintain the data as a temporal stream of data. Thus, the monitoring module 320 acquires data from the vehicle-equipped detachable sensor 130, 430 and stores the data in the database 350 for future analysis. The monitoring module 320 configures the vehicle-equipped detachable sensor 130, 430 to detect objects associated with the acquired data in the environment around the non-automotive entity 140, 440 when the vehicle-equipped detachable sensor 130, 430 is mounted to the non-automotive entity 140, 440. The method 500 then proceeds to block 530.

At block 530, the identification module 330 identifies, from on the acquired data, based on the selected object type received from the mobile device 150. The identification module 330 cross-references the selected object type with the data stored in the object classification database 360 to determine, for example, a representative image or stored sensor reading corresponding to the selected object type. The representative image is then compared to the detected object to determine whether the representative image or stored sensor reading is substantially the same as the detected object. If they are substantially the same, i.e., the detected object has been identified as the object 160, 460 matching the selected object type, the method 500 proceeds to block 540, Otherwise, the method 500 proceeds to block 520 so that the monitoring module 320 may acquire more data from the vehicle-equipped detachable sensor 130, 430.

At block 540, as a result of the identification module 330 identifying the object 160, 460 from the acquired data, the notification module 335 can output at least one notification signal to the mobile device 150. The mobile device 150 may receive the notification signal, decode the notification signal and direct the decoded information to the appropriate output system 260 of the mobile device 150. The notification signal informs the operator or the non-automotive entity 140, 440 that adapts the vehicle-equipped detachable sensor 130, 430 as a wearable device of the presence of the object 160, 460 in the environment around the non-automotive entity 140, 440. After the notification signal is output the mobile device 150 and channeled to the appropriate output system 260 of the mobile device 150, the method 500 proceeds to block 550.

At block 550, the tracking module 340 can determine the tracking information about the object 160, 460 from the acquired data. The tracking information may induce the position of the object 160, 460, the velocity of the object 160, 460, the elevation of the object 160, 460 and the current and predicted trajectories of the object 160, 460. The predicted trajectory of the object 160, 460 may also be determined from predefined characteristics of the object 160, 460 that are stored in the predefined characteristics database 370 for the detected object that has been classified, i.e., the detected object identified as the object 160, 460 matching the selected object type. In response to determining the tracking information, i.e., at least one static or dynamic determination regarding the object 160, 460, the method proceeds to block 560.

At block 560, as a result of the tracking module 330 determining the tracking information about the object 160, 460, the notification module 335 can output at least one tracking signal to the mobile device 150. The mobile device 150 may receive the tracking signal corresponding to the tracking information, decode the tracking signal and direct the decoded information to the appropriate output system 260 of the mobile device 150. The tracking signal informs the operator or the non-automotive entity 140, 440 that adapts the vehicle-equipped detachable sensor 130, 430 as a wearable device of the static or dynamic behavior of the object 160, 460. After the tracking signal is output the mobile device 150 and channeled to the appropriate output system 260 of the mobile device 150, the method 500 is then terminated.

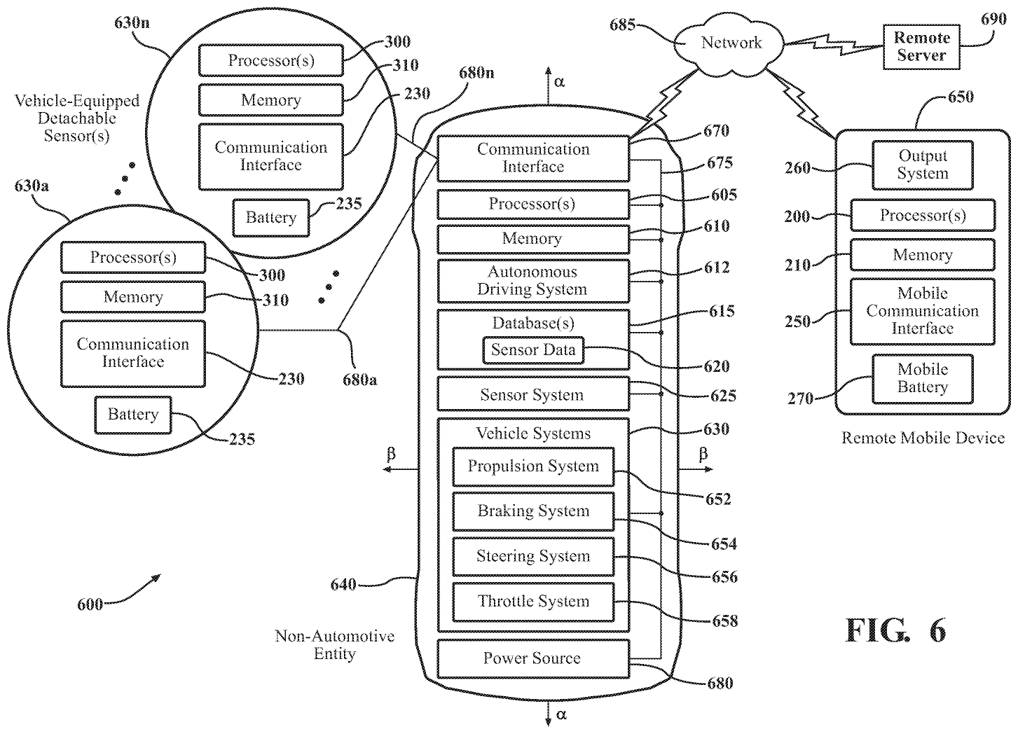

FIG. 6 illustrates an example object identification system 600 that allows for unmanned operation of a non-automotive entity 640, which may, for example, allow for object identification and tracking of the object 160 from a remote location. For example, the movement of a non-automotive entity 640 may be controlled remotely from, e.g., a remotely located mobile device (herein referred to as a “remote mobile device 650”), a remote server 690, another remotely located computing device (not shown), etc., by a user of these remote devices (herein referred to as a “remote user”). As another example, the non-automotive entity 640 may have full autonomous control capability, and an area to be remotely monitored for object identification and tracking may be received from the remote user by the non-automotive entity 640 via, e.g., an application running on the remote mobile device 650, a program running on the remote server 690, etc.

In either case, the object identification system 600, as shown in FIG. 6, may be used for remote object identification and tracking of the object 160 while the non-automotive entity 640 is unmanned and being controlled remotely by the remote user or traveling autonomously with navigation parameters received from the remote user. Additionally, the remote user may monitor the movement (or lack thereof) of the object 160 via the tracking information that is output from the tracking module 335 to, for example, the remote mobile device 650, the remote server 690, etc. The object identification system 600 may be particularly useful for object identification, detection and tracking of the object 160 in an environment, for example, that is not conducive to human travel, e.g., detecting a specific type of bird with the non-automotive entity 640 (e.g., an aerial drone), detecting specific types of lifeforms in a wildfire with the non-automotive entity 640 configured to withstand high temperatures, etc. The elements of the object identification system 600 that allow remote functionality will now be described.

With continued reference to FIG. 6, The object identification system 600 includes the non-automotive entity 640 capable of remote and/or autonomous control, one or more vehicle-equipped detachable sensors 630, e.g., 630a-630n, and both the remote mobile device 650 and the remote server 690 communicably coupled to the non-automotive entity 640 via a network 685. The vehicle-equipped detachable sensors 630 are configured as a “smart sensors,” i.e., containing the processor(s) 300 and may include at least a portion of the memory 310. As described further below, an autonomous driving system 612 of the non-automotive entity 640 may be enhanced by the capabilities of the object identification system 600.

The non-automotive entity 640 can include various elements. Some of the possible elements of the non-automotive entity 640 that may allow for remote functionality are shown in FIG. 6 and will now be described. However, it should be understood that it is not necessary for the non-automotive entity 640 to include all of the elements shown in FIG. 6 or described herein. The non-automotive entity 640 can have any combination of the various elements shown in FIG. 6, Furthermore, the non-automotive entity 640 can have additional elements to those shown in FIG. 6. Further, while various elements are shown as being located within the non-automotive entity 640, one or more of these elements can be located external to the non-automotive entity 640, and the elements shown may be physically separated by large distances.

The non-automotive entity 640 can include one or more processors 605. The processor(s) 605 can be any component or group of components that are configured to execute any of the processes attributable to the operation of the non-automotive entity 640 or any form of instructions to carry out such processes or cause such processes to be performed.

The non-automotive entity 640 can include a memory 610. The memory 610 can include one or more forms of computer-readable media, and store instructions executable by the processor(s) 605 for performing various operations of the non-automotive entity 640. Examples of suitable memory 610 includes RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

The processor(s) 300 and the memory 310 of the object identification system 600 may be completely contained within the vehicle-equipped detachable sensors 630, the remote mobile device 650, the non-automotive entity 640, the remote server 690 or be distributed among the vehicle-equipped detachable sensors 630, the remote mobile device 650, the non-automotive entity 640 and/or the remote server 690. The processor(s) 605 and the memory 610 may be a part of the object identification system 600, the object identification system 600 may include separate processor(s) and memory from the processors(s) 605 and the memory 610, or the object identification system 600 may access the processor(s) 605 and the memory 610 through a data bus or another communications path. In the same manner as the non-automotive entity 640, the processor(s) and memory of the remote server 690 may include the processor(s) 300 and/or memory 310 functionality. As an example of a completely distributed object identification system 600, the vehicle-equipped detachable sensors 630 may include one of the processor(s) 300 and the memory 310 executing and storing the monitoring module 320, respectively, the remote mobile device 650 may include one of the processor(s) 300 and the memory 310 executing and storing the identification module 330 and the notification module 335, respectively, and the non-automotive entity 640 (or the remote server 690) may include one of the processor(s) 300 and the memory 310 executing and storing the tracking module 340, respectively.

In either case, in one or more arrangements of the object identification system 600, the vehicle-equipped detachable sensors 630 may include at least one of the one or more processors 300 and the memory 310, the remote mobile device 650 may include at least one of the one or more processors 300, the memory 310 and the non-automotive entity 640 may include at least one of the one or more processors 300 and the memory 310 and the remote server 690 may include at least one of the one or more processors 300 and the memory 310. The processor(s) 200, the processor(s) 300, the processor(s) 605 and the processor(s) of the remote server may be operatively connected to each other and may process any portion of the modules 320, 325, 330, 335, and 340 in any combination. The memory 210, the memory 310, the memory 610 and the memory of the remote server may be operatively connected to each other and may store any portion of the modules 320, 325, 330, 335, and 340 in any combination.

The non-automotive entity 640 can include one or more databases 615 for storing one or more types of data. The database(s) 615 can be a component of the memory 610, the processor(s) 605, or the database(s) 615 can be operatively connected to the processor(s) 605 and/or the memory 610 for use thereby. The database(s) 615 can include sensor data 620. In this context, “sensor data 620” means any information about the sensors that the non-automotive entity 640 is equipped with. As will be explained below, the non-automotive entity 640 can include a sensor system 625. The sensor data 620 can relate to one or more sensors of the sensor system 625. The database(s) 615 may be a part of the object identification system 600 and may store a portion of the database 350 of the object identification system 600, e.g., the object classification database 360, the predetermined characteristics database 370, etc.

The non-automotive entity 640 can include one or more modules, at least some of which are described herein. The modules can be implemented as computer-readable program code that, when executed by a processor, implement one or more of the various processes described herein. One or more of the modules can be a component of the processor(s) 605, or one or more of the modules can be executed on and/or distributed among other processing systems to which the processor(s) 605 is operatively connected. The modules can include instructions (e.g., program logic) executable by one or more processor(s) 605. Alternatively, or in addition, one or more databases 615 may contain such instructions.

The non-automotive entity 640 can also include a sensor system 625. The sensor system 625 can include one or more sensors. The one or more sensors can be configured to monitor something in the environment around the non-automotive entity 640. The one or more sensors can detect, determine, and/or sense information about the non-automotive entity 640 itself. The sensor system 625 can be positioned anywhere in or on the non-automotive entity 640. The one or more sensors can be configured to detect, and/or sense in real-time.

In arrangements in which the sensor system 625 includes a plurality of sensors, the sensors can work independently from each other. Alternatively, two or more of the sensors can work in combination with each other. In such case, the two or more sensors can form a sensor network. The sensor system 625 and/or the one or more sensors can be operatively connected to the processor(s) 605, the database(s) 615, and/or another element of the non-automotive entity 640. The sensor system 625 can acquire data of at least a portion of the external environment of the non-automotive entity 640.

The non-automotive entity 640 can include a communication interface 670. The communication interface 670 of the non-automotive entity 640 is implemented via an antenna, circuits, chips, or other electronic components that facilitate wired and/or wireless communication between the components of the remote mobile device 650 and the non-automotive entity 640 via the network 685, as well as between the vehicle-equipped detachable sensors 630 and the non-automotive entity 640 via one or more second links 680, e.g., 680a-680n. The communication interface 670 may be programmed to communicate in accordance with any number of wired or wireless communication protocols. For instance, the communication interface 670 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, the Local Interconnect Network (LEN) protocol, the Universal Serial Bus (USB) protocol, etc.

The non-automotive entity 640 may be configured so that the components of the non-automotive entity 640 can communicate with each other using a controller area network (CAN) bus 675 or the like. Alternatively, any of the elements and/or systems described herein may be directly connected to each other without the use of a bus. Also, connections between the elements and/or systems described herein may be through another physical medium (such as wired connections), or the connections may be wireless connections.

The non-automotive entity 640 can include a power source 680. The power source 680 may provide power to one or more systems and/or subsystems of the non-automotive entity 640. The power source 680 may be, for example, a rechargeable battery (e.g., lithium ion, lead acid, etc.), a generator, etc. The power source 680 may be used to power and/or recharge the battery 235 of the vehicle-equipped detachable sensors 630 via the one or more second links 480.

The non-automotive entity 640 can include one or more vehicle systems 630 that effect movement of the non-automotive entity 640. Various examples of the one or more vehicle systems 630 that effect movement of the non-automotive entity 640 are shown in FIG. 6. However, the non-automotive entity 640 can include more, fewer, or different vehicle systems 630. It should be appreciated that although particular vehicle systems 630 are separately defined, each or any of the systems or portions thereof may be otherwise combined or segregated via hardware and/or software within the non-automotive entity 640. The non-automotive entity 640 can include, e.g., a propulsion system 652, a braking system 654, a steering system 656 and a throttle system 658. Each of these systems can include one or more devices, components, and/or combination thereof, now known or later developed.

The non-automotive entity 640 can include the autonomous driving system 612. The autonomous driving system 612 may be configured to operate in a full autonomous mode. More specifically, the non-automotive entity 640 may operate in an autonomous mode without human intervention through receiving control instructions from the autonomous driving system 612. The autonomous driving system 612 may include control instructions that when processed by the processor(s) 605 cause the non-automotive entity 640 to, for example, accelerate (e.g., by, commanding the propulsion system 652 to increase the supply of fuel, and/or the throttle system 658 in increase speed), decelerate (e.g., by commanding the propulsion system 652 to decrease the supply of fuel, and/or the braking system 654 to apply the brakes), and/or change direction (e.g., by commanding the steering system 656 to turn the front two wheels). As used herein, “cause” or “causing” means to make, force, compel, direct, command, instruct, and/or enable an event or action to occur or at least be in a state where such event or action may occur, either in a direct or indirect manner.

The autonomous driving system 612 can be configured to determine travel path(s), current autonomous driving maneuvers for the non-automotive entity 640, future autonomous driving maneuvers and/or modifications to current autonomous driving maneuvers based on data from the sensors of the sensor system 625 and/or other systems of the non-automotive entity 640 (not shown) to enable safe navigation to an intended destination. “Driving maneuver” means one or more actions that effect movement of the non-automotive entity 640. Examples of driving maneuvers include: accelerating, decelerating, braking, turning, moving in a lateral direction of the non-automotive entity 640, changing travel lanes, merging into travel lane, and/or reversing, just to name a few possibilities.

The autonomous driving system 612 may be enhanced by the addition of the one or more vehicle-equipped detachable sensors 630 from the automotive vehicle 110. For example, the non-automotive entity 440 may be equipped with basic autonomous capabilities, e.g., limited range sensors, limited maneuverable capability, etc. as compared to the autonomous capabilities of the automotive vehicle 110. The autonomous driving system 612 may utilize the information generated by the object identification system 600, i.e., the object identification system 600 may share information with the autonomous driving system 612 For example, the autonomous driving system 612 may utilize the acquired data from the monitoring module 320, i.e., the data from the vehicle-equipped detachable sensors 630, to enhance the current and/or future autonomous driving maneuvers.

The remote mobile device 650 includes devices that are configured to communicate with the non-automotive entity 640 in a wireless fashion via the network 685. The remote mobile device 650 may be, for example, a smart phone, a tablet, phablets, laptop computer, etc., or any other mobile computing device that may be capable of wireless communication with the non-automotive entity 640 via the network 685.

For example, in one arrangement, the remote mobile device 650 may receive the tracking signal from the tracking module 335 remotely. In this case, the tracking module 335 may be stored in the memory 610 and executed by the processor(s) 605 of the non-automotive entity 640. In another arrangement, the remote mobile device 650 may include the monitoring module 320 and the vehicle-equipped detachable sensors 630 can be configured to communicate with the remote mobile device 650 through the non-automotive entity 640. For example, the remote mobile device 650 may acquire data from the vehicle-equipped detachable sensors 630 that are configured to transmit data through a gateway facilitated by the communication interface 670 of the non-automotive entity 640.

The network 685 represents one or more mechanisms by which the non-automotive entity 640 via the communication interface 670, the remote mobile device 650 via the mobile communication interface 250 and the remote server 690 may communicate with each other. The network 685 may include one or more known networks and/or networking technologies, such as wireless communication networks (e.g., Bluetooth, WEE 802.11, etc.), a cellular network, local area networks (LAN) and/or wide area networks (WAN), including the Internet, providing data communication services.

The remote server 690 is a computer including a processor and a memory, the memory stores instructions which may be executed by the processor. For example, in one arrangement, the remote server 690 may receive the notification signal and tracking signal from the notification module 335 that is stored in the memory 610 of the non-automotive entity 640.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The teen “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An object identification system comprising:
a vehicle-equipped detachable sensor capable of sensing a portion of an environment around an automotive vehicle and configured to communicate with a mobile device, the vehicle-equipped detachable sensor structured to be detached from the automotive vehicle and mounted to a non-automotive entity;
one or more processors;
a memory communicably coupled to the one or more processors and storing:
a monitoring module including instructions that when executed by the one or more processors cause the one or more processors to acquire data from the vehicle-equipped detachable sensor of an environment around the non-automotive entity when the vehicle-equipped detachable sensor is mounted to the non-automotive entity;
an identification module including instructions that when executed by the one or more processors cause the one or more processors to identify, from the acquired data, an object based on a selected object type received from the mobile device; and
a notification module including instructions that when executed by the one or more processors cause the one or more processors to, in response to identifying the object from the acquired data, output at least one notification signal to the mobile device.

2. The object identification system of claim 1, further comprising a tracking module, the tracking module including instructions that when executed by the one or more processors cause the one or more processors to determine tracking information about the object that has been identified based at least in part on one or more of a classification of the object and the acquired data.

3. The object identification system of claim 2, wherein the tracking information includes at least one of a position of the object, a velocity of the object, an elevation of the object, a current trajectory of the object, and a predicted trajectory of the object.

4. The object identification system of claim 2, wherein the notification module further includes instructions to, in response to determining the tracking information, output at least one tracking signal to the mobile device.

5. The object identification system of claim 2, wherein the tracking module further includes instructions to determine whether the object comes within a predetermined distance of the non-automotive entity.

6. The object identification system of claim 1, wherein the vehicle-equipped detachable sensor includes at least one of the one or more processors, the memory, and a battery.

7. The object identification system of claim 1, wherein the vehicle-equipped detachable sensor is configured to wirelessly communicate with the mobile device.

8. The object identification system of claim 1, wherein the vehicle-equipped detachable sensor is configured to communicate with the mobile device through the non-automotive entity.

9. The object identification system of claim 1, wherein the mobile device includes at least one of the one or more processors and the memory.

10. The object identification system of claim 1, further comprising a calibration module, the calibration module including instructions that when executed by the one or more processors cause the one or more processors to calibrate the vehicle-equipped detachable sensor to a portion of the environment around the non-automotive entity based at least in part on mounting location parameters associated with a mounting location of the vehicle-equipped detachable sensor on the non-automotive entity.

11. A method comprising:
acquiring data from a vehicle-equipped detachable sensor of an environment around a non-automotive entity when the vehicle-equipped detachable sensor is mounted to the non-automotive entity, the vehicle-equipped detachable sensor capable of sensing a portion of an environment around an automotive vehicle and configured to communicate with a mobile device, the vehicle-equipped detachable sensor structured to be detached from the automotive vehicle and mounted to the non-automotive entity;
identifying, from the acquired data, an object based on a selected object type received from the mobile device; and
in response to identifying the object from the acquired data, outputting at least one notification signal to the mobile device.

12. The method of claim 11 further comprising:
determining tracking information about the object that has been identified based at least in part on one or more of a classification of the object and the acquired data.

13. The method of claim 12, wherein the tracking information includes at least one of a position of the object, a velocity of the object, an elevation of the object, a current trajectory of the object, and a predicted trajectory of the object.

14. The method of claim 12 further comprising:
in response to determining the tracking information, outputting at least one tracking signal to the mobile device.

15. The method of claim 12 further comprising:
determining whether the object comes within a predetermined distance of the non-automotive entity.

16. A non-transitory computer-readable medium and storing instructions that when executed by one or more processors cause the one or more processor to:
acquire data from a vehicle-equipped detachable sensor of an environment around a non-automotive entity when the vehicle-equipped detachable sensor is mounted to the non-automotive entity, the vehicle-equipped detachable sensor capable of sensing a portion of an environment around an automotive vehicle and configured to communicate with a mobile device, the vehicle-equipped detachable sensor structured to be detached from the automotive vehicle and mounted to the non-automotive entity;
identify, from the acquired data, an object based on a selected object type received from the mobile device; and
in response to identifying the object from the acquired data, output at least one notification signal to the mobile device.

17. The non-transitory computer-readable medium of claim 16, wherein the computer-readable medium further includes instructions that when executed by the one or more processors cause the one or more processors to:
determine tracking information about the object that has been identified based at least in part on one or more of a classification of the object and the acquired data.

18. The non-transitory computer-readable medium of claim 17, wherein the tracking information includes at least one of a position of the object, a velocity of the object, an elevation of the object, a current trajectory of the object, and a predicted trajectory of the object.

19. The non-transitory computer-readable medium of claim 17, wherein the computer-readable medium further includes instructions that when executed by the one or more processors cause the one or more processors to:
in response to determining the tracking information, output at least one tracking signal to the mobile device.

20. The non-transitory computer-readable medium of claim 17, wherein the computer-readable medium further includes instructions that when executed by the one or more processors cause the one or more processors to:
determine whether the object comes within a predetermined distance of the non-automotive entity.
